(19) United States
(12) Patent Application Publication
(10) Pub. No.: US 2022/0183090 A1
(43) Pub. Date: Jun. 9, 2022

(54) BACKHAUL CHANNEL MANAGEMENT FOR IAB NETWORKS

(71) Applicant: Telefonaktiebolaget LM Ericsson (publ), Stockholm (SE)

(72) Inventors: Gunnar MILDH, Sollentuna (SE); Oumer TEYEB, Montréal (CA); Ajmal MUHAMMAD, Sollentuna (SE)

(73) Assignee: Telefonaktiebolaget LM Ericsson (publ), Stockholm (SE)

(21) Appl. No.: 17/598,541

(22) PCT Filed: Mar. 27, 2020
(86) PCT No.: PCT/IB2020/052937

§ 371 Date: Sep. 27, 2021

Related U.S. Application Data
(60) Provisional application No. 62/825,508, filed on Mar. 28, 2019.

(51) Int. Cl. H04W 76/12; H04W 76/20

(52) U.S. Cl. CPC H04W 76/12; H04W 92/24; H04W 76/20

(57) ABSTRACT

A method for establishing a BH RLC channel between a node and a DU is provided. The method includes the DU receiving an F1AP message from a CU; the DU determining that the DU is capable to establish the BH RLC channel between the node and the DU in response to receiving the F1AP message; and the DU generating an RRC configuration for the BH RLC channel. The RRC configuration includes: i) a BH-RLC-Identity value which indicates an identifier for the BH RLC channel, the BH-RLC-Identity field being part of a served BHChannel Information Element (IE), or ii) a drb-Identity value that is associated with the BH RLC channel, or iii) a logical channel identity (LCID) value that is associated with the BH RLC channel, or iv) a RLC-ChannelConfig IE that includes an identifier for the BH RLC channel.

### TECHNICAL FIELD

Disclosed are embodiments related to backhaul channel management for integrated access and wireless access backhaul (IAB) networks.

### BACKGROUND

I. Integrated Access Backhaul Networks

The 3rd Generation Partnership Project (3GPP) is currently standardizing integrated access and wireless access backhaul (IAB) in New Radio (NR) in 3GPP Rel-16 (RP-182882).

The usage of short range mmWave spectrum in NR creates a need for densified deployment with multi-hop backhauling. However, optical fiber to every base station will be too costly and sometimes not even possible (e.g. historical sites). The main IAB principle is the use of wireless links for the backhaul (instead of fiber) to enable flexible and very dense deployment of cells without the need for densifying the transport network. Use case scenarios for IAB can include coverage extension, deployment of massive number of small cells and fixed wireless access (FWA) (e.g. to residential/office buildings). The larger bandwidth available for NR in mmWave spectrum provides opportunity for self-backhauling, without limiting the spectrum to be used for the access links. On top of that, the inherent multi-beam and MIMO support in NR reduces cross-link interference between backhaul and access links allowing higher densification.

During the study item phase of the IAB work (summary of the study item can be found in the 3GPP technical report (TR) 38.874 V16.0.0) it has been agreed to adopt a solution that leverages the Central Unit (CU)/Distributed Unit (DU) split architecture of NR, where the IAB node will be hosting a DU part that is controlled by a CU. The IAB nodes also have a Mobile Termination (MT) part that they use to communicate with their parent nodes.

The specifications for IAB strive to reuse existing functions and interfaces defined in NR. In particular, MT, gNB-DU, gNB-CU, UPF, AMF and SMF as well as the corresponding interfaces NR Uu (between MT and gNB), F1, NG, X2 and N4 are used as baseline for the IAB architectures. Modifications or enhancements to these functions and interfaces for the support of IAB will be explained in the context of the architecture discussion. Additional functionality such as multi-hop forwarding is included in the architecture discussion as it is necessary for the understanding of IAB operation and since certain aspects may require standardization.

The Mobile-Termination (MT) function has been defined as a component of the IAB node. MT is referred to as a function residing on an IAB-node that terminates the radio interface layers of the backhaul Uu interface toward the IAB-donor or other IAB-nodes.

FIG. 1 shows a reference diagram for IAB in standalone mode, which contains one IAB-donor and multiple IAB-nodes. The IAB-donor is treated as a single logical node that comprises a set of functions such as gNB-DU, gNB-CU-CP, gNB-CU-UP and potentially other functions. In a deployment, the IAB-donor can be split according to these functions, which can all be either collocated or non-collocated as allowed by 3GPP NG-RAN architecture. IAB-related aspects may arise when such split is exercised. Also, some of the functions presently associated with the IAB-donor may eventually be moved outside of the donor in case it becomes evident that they do not perform IAB-specific tasks.

The baseline user plane and control plane protocol stacks for IAB are shown in FIG. 2 and FIG. 3.

As shown in FIG. 2 and FIG. 3, the chosen protocol stacks reuse the current CU-DU split specification in release 15 (rel-15), where the full user plane F1-U (GTP-U/UDP/IP) is terminated at the IAB node (like a normal DU) and the full control plane F1-C (F1AP/SCTP/IP) is also terminated at the IAB node (like a normal DU). In the above cases, Network Domain Security (NDS) has been employed to protect both UP and CP traffic (IPsec in the case of UP, and DTLS in the case of CP). IPsec could also be used for the CP protection instead of DTLS (in this case no DTLS layer would be used).

A new layer, called adaptation layer (the final name of this layer to be used in the standard is still pending), has been introduced in the IAB nodes and the IAB donor, which is used for routing of packets to the appropriate downstream/upstream node and also mapping the UE bearer data to the proper backhaul RLC channel (and also between ingress and egress backhaul RLC channels in intermediate IAB nodes) to satisfy the end to end QoS requirements of bearers.

II. Radio Bearer Configuration in NR

Radio bearers is a concept used both in LTE and NR. The radio bearers provide transfer of data packets or signaling messages over the radio interface. Each radio bearer is typically associated with an instance of the PDCP and RLC protocols on both the UE and network side.

In legacy LTE, the UE was configured with an RRC configuration that included the information of both lower and higher layer aspects in one common information element (IE) (radioResourceConfigDedicated). In NR (and also LTE rel-15, where LTE can be used in dual connectivity mode with a non-standalone NR cell), the structure has been modified so that the lower and higher layer configurations are split in different IEs.

The upper layer aspects (PDCP and SDAP) are configured using the radioBearerConfig IE, while the lower layer configurations are done via the cellGroupConfig IE that are part of the RRCReconfiguration message.

The structure of the different messages/IEs is shown below.

| | |
|---|---|
| RRCReconfiguration ::= | SEQUENCE { |
| rrc-TransactionIdentifier | RRC-TransactionIdentifier, |
| criticalExtensions | CHOICE { |
| rrcReconfiguration | RRCReconfiguration-IEs, |
| criticalExtensionsFuture | SEQUENCE { } |

}
}

| | |
|---|---|
| RRCReconfiguration-IEs ::= | SEQUENCE { |
| radioBearerConfig | RadioBearerConfig OPTIONAL, -- Need M |
| secondaryCellGroup | OCTET STRING (CONTAINING CellGroupConfig) |

OPTIONAL, -- Need M

| | |
|---|---|
| measConfig | MeasConfig OPTIONAL, -- Need M |
| lateNonCriticalExtension | OCTET STRING OPTIONAL, |
| nonCriticalExtension | RRCReconfiguration-v1530-IEs OPTIONAL |

}

| | |
|---|---|
| RRCReconfiguration-v1530-IEs ::= | SEQUENCE { |

masterCellGroup OCTET STRING (CONTAINING CellGroupConfig) OPTIONAL, --
Need M

| | |
|---|---|
| fullConfig | ENUMERATED {true} OPTIONAL, -- Cond FullConfig |
| dedicatedNAS-MessageList | SEQUENCE (SIZE(1..maxDRB)) OF DedicatedNAS-Message |

OPTIONAL, -- Cond nonHO

| | |
|---|---|
| masterKeyUpdate | MasterKeyUpdate OPTIONAL, -- Cond MasterKeyChange |
| dedicatedSIB1-Delivery | OCTET STRING (CONTAINING SIB1) OPTIONAL, -- |

Need N

| | |
|---|---|
| dedicatedSystemInformationDelivery | OCTET STRING (CONTAINING |
| Systeminformation) | OPTIONAL, -- Need N |
| otherConfig | OtherConfig OPTIONAL, -- Need M |
| nonCriticalExtension | RRCReconfiguration-v1540-IEs OPTIONAL |

}

| | |
|---|---|
| RRCReconfiguration-v1540-IEs :: = | SEQUENCE { |
| otherConfig-v1540 | OtherConfig-v1540 OPTIONAL, -- Need M |
| nonCriticalExtension | RRCReconfiguration-v15xy-IEs OPTIONAL |

}

| | |
|---|---|
| RRCReconfiguration-v15xy-IEs ::= | SEQUENCE { |

```
  mrdc-SecondaryCellGroupConfig SetupRelease {MRDC-SecondaryCellGroupConfig}
    OPTIONAL, -- Need M
```

| | |
|---|---|
| radioBearerConfig2 | OCTET STRING (CONTAINING RadioBearerConfig) |

OPTIONAL, -- Need M

| | |
|---|---|
| sk-Counter | SK-Counter OPTIONAL, -- Need N |
| nonCriticalExtension | SEQUENCE { } OPTIONAL |

}

| | |
|---|---|
| MRDC-SecondaryCellGroupConfig ::= | SEQUENCE { |
| mrdc-ReleaseAndAdd-r15 | ENUMERATED {true} OPTIONAL, -- Need N |
| mrdc-SecondaryCellGroup | CHOICE { |
| nr-SCG | OCTET STRING, |
| eutra-SCG | OCTET STRING |

} OPTIONAL -- Need M
}

| MasterKeyUpdate ::= | SEQUENCE { | |
|---|---|---|
| keySetChangeIndicator | BOOLEAN, | |
| nextHopChainingCount | NextHopChainingCount, | |
| nas-Container | OCTET STRING | OPTIONAL, -- Cond securityNASC |

...
}

| | |
|---|---|
| RadioBearerConfig ::= | SEQUENCE { |
| srb-ToAddModList | SRB-ToAddModList OPTIONAL, -- CondHO-Conn |
| srb3-ToRelease | ENUMERATED {true} OPTIONAL, -- Need N |
| drb-ToAddModList | DRB-ToAddModList OPTIONAL, -- Cond HO-toNR |
| drb-ToReleaseList | DRB-ToReleaseList OPTIONAL, -- Need N |
| securityConfig | SecurityConfig OPTIONAL, -- Need M |

...
}

| | |
|---|---|
| SRB-ToAddModList ::= | SEQUENCE (SIZE (1..2)) OF SRB-ToAddMod |
| SRB-ToAddMod ::= | SEQUENCE { |
| srb-Identity | SRB-Identity, |
| reestablishPDCP | ENUMERATED{true} OPTIONAL, -- Need N |
| discardOnPDCP | ENUMERATED{true} OPTIONAL, -- Need N |
| pdcp-Config | PDCP-Config OPTIONAL, -- Cond PDCP |

...
}

| | |
|---|---|
| DRB-ToAddModList ::= | SEQUENCE (SIZE (1.maxDRB)) OF DRB-ToAddMod |
| DRB-ToAddMod ::= | SEQUENCE { |
| cnAssociation | CHOICE { |
| eps-BearerIdentity | INTEGER (0..15), -- EPS-DRB-Setup |
| sdap-Config | SDAP-Config -- 5GC |

} OPTIONAL, -- Cond DRBSetup

| | |
|---|---|
| drb-Identity | DRB-Identity, |
| reestablishPDCP | ENUMERATED{true} OPTIONAL, -- Need N |
| recoverPDCP | ENUMERATED{true} OPTIONAL, -- Need N |
| pdcp-Config | PDCP-Config OPTIONAL, -- Cond PDCP |

...
}

| | |
|---|---|
| DRB-ToReleaseList ::= | SEQUENCE (SIZE (1..maxDRB)) OF DRB-Identity |
| SecurityConfig ::= | SEQUENCE { |
| securityAlgorithmConfig | SecurityAlgorithmConfig OPTIONAL, -- Cond |

RBTermChange

| | | |
|---|---|---|
| keyToUse | ENUMERATED {master, secondary} | OPTIONAL, |

-- Cond RBTermChange
...
}

| | |
|---|---|
| CellGroupConfig ::= | SEQUENCE { |
| cellGroupId | CellGroupId, |
| rlc-BearerToAddModList | SEQUENCE (SIZE(1..maxLC-ID)) OF RLC- |
| BearerConfig | OPTIONAL, -- Need N |
| rlc-BearerToReleaseList | SEQUENCE (SIZE(1..maxLC-ID)) OF |
| LogicalChannelIdentity | OPTIONAL, -- Need N |
| mac-CellGroupConfig | MAC-CellGroupConfig OPTIONAL, -- Need M |
| physicalCellGroupConfig | PhysicalCellGroupConfig OPTIONAL, -- Need M |
| spCellConfig | SpCellConfig OPTIONAL, -- Need M |
| sCellToAddModList | SEQUENCE (SIZE (1..maxNrofSCells)) OF |
| SCellConfig | OPTIONAL, -- Need N |
| sCellToReleaseList | SEQUENCE (SIZE (1..maxNrofSCells)) OF SCellIndex |

```
OPTIONAL, -- Need N
  ...,
  [[
  reportUplinkTxDirectCurrent-v1530 ENUMERATED {true}
OPTIONAL -- Cond BWP-Reconfig
  ]]
}
-- Serving cell specific MAC and PHY parameters for a SpCell:
```

| | |
|---|---|
| SpCellConfig ::= | SEQUENCE { |
| servCellIndex | ServCellIndex OPTIONAL, -- Cond SCG |
| reconfigurationWithSync | ReconfigurationWithSync OPTIONAL, -- Cond |

ReconfWithSync

| | |
|---|---|
| rlf-TimersAndConstants | SetupRelease { RLF-TimersAndConstants } |

OPTIONAL, -- Need M

| | |
|---|---|
| rlmInSyncOutOfSyncThreshold | ENUMERATED {n1} OPTIONAL, -- Need S |
| spCellConfigDedicated | ServingCellConfig OPTIONAL, -- Need M |

...
}

| | |
|---|---|
| ReconfigurationWithSync ::= | SEQUENCE { |
| spCellConfigCommon | ServingCellConfigCommon OPTIONAL, -- Need M |

| | |
|---|---|
| newUE-Identity | RNTI-Value, |
| t304 | ENUMERATED {ms50, ms100, ms150, ms200, ms500, ms1000, |

ms2000, ms10000},

| | |
|---|---|
| rach-ConfigDedicated | CHOICE { |
| uplink | RACH-ConfigDedicated, |
| supplementaryUplink | RACH-ConfigDedicated |

```
  } OPTIONAL, -- Need N
  ...,
  [[
```

| | | |
|---|---|---|
| smtc | SSB-MTC | OPTIONAL -- |

Need S
]]
}

| | |
|---|---|
| SCellConfig ::= | SEQUENCE { |
| sCellIndex | SCellIndex, |
| sCellConfigCommon | ServingCellConfigCommon OPTIONAL, -- Cond |

SCellAdd

| | |
|---|---|
| sCellConfigDedicated | ServingCellConfig OPTIONAL, -- Cond SCellAddMod |

```
  ...,
  [[
```

| | | |
|---|---|---|
| smtc | SSB-MTC | OPTIONAL -- Need S |

]]
}

| | |
|---|---|
| RLC-BearerConfig ::= | SEQUENCE { |
| logicalChannelIdentity | LogicalChannelIdentity, |
| servedRadioBearer | CHOICE { |
| srb-Identity | SRB-Identity, |
| drb-Identity | DRB-Identity |

} OPTIONAL, -- Cond LCH-SetupOnly

| | |
|---|---|
| reestablishRLC | ENUMERATED {true} OPTIONAL, -- Need N |
| rlc-Config | RLC-Config OPTIONAL, -- Cond LCH-Setup |
| mac-LogicalChannelConfig | LogicalChannelConfig OPTIONAL, -- Cond LCH- |

```
Setup
  ...
}
PDCP-Config ::= SEQUENCE {
  drb SEQUENCE {
```

| | |
|---|---|
| discardTimer | ENUMERATED {ms10, ms20, ms30, ms40, ms50, ms60, ms75, |

ms100, ms150, ms200,

| | |
|---|---|
| ms250, ms300, ms500, ms750, ms1500, infinity} | OPTIONAL, |

-- Cond Setup

| | |
|---|---|
| pdcp-SN-SizeUL | ENUMERATED {len12bits, len18bits} |

OPTIONAL, - Cond Setup2

| | |
|---|---|
| pdcp-SN-SizeDL | ENUMERATED {len12bits, len18bits} |

OPTIONAL, -- Cond Setup2

| headerCompression | CHOICE { | |
|---|---|---|
| notUsed | NULL, | |
| rohc | SEQUENCE { | |
| maxCID | INTEGER (1..16383) | DEFAULT 15, |

| | |
|---|---|
| profiles | SEQUENCE { |
| profile0x0001 | BOOLEAN, |
| profile0x0002 | BOOLEAN, |
| profile0x0003 | BOOLEAN, |
| profile0x0004 | BOOLEAN, |
| profile0x0006 | BOOLEAN, |
| profile0x0101 | BOOLEAN, |
| profile0x0102 | BOOLEAN, |
| profile0x0103 | BOOLEAN, |
| profile0x0104 | BOOLEAN |

},

| | |
|---|---|
| drb-ContinueROHC | ENUMERATED { true } |

OPTIONAL -- Need N
},

| uplinkOnlyROHC | SEQUENCE { | |
|---|---|---|
| maxCID | INTEGER (1..16383) | DEFAULT 15, |

| | |
|---|---|
| profiles | SEQUENCE { |
| profile0x0006 | BOOLEAN |

},

| | |
|---|---|
| drb-ContinueROHC | ENUMERATED { true } |

```
OPTIONAL -- Need N
      },
      ...
    },
    integrityProtection ENUMERATED { enabled }
OPTIONAL, -- Cond ConnectedTo5GC
    statusReportRequired ENUMERATED {true }
OPTIONAL, -- CondRlc-AM
    outOfOrderDelivery ENUMERATED { true }
OPTIONAL -- Need R
```

| } | | OPTIONAL, -- Cond DRB |
|---|---|---|
| moreThanOneRLC | SEQUENCE { | |
| primaryPath | SEQUENCE { | |
| cellGroup | CellGroupId | OPTIONAL, -- Need R |
| logicalChannel | LogicalChannelIdentity | OPTIONAL -- |

Need R
},

| | |
|---|---|
| ul-DataSplitThreshold UL-DataSplitThreshold | OPTIONAL, - |

- Cond SplitBearer

| | | |
|---|---|---|
| pdcp-Duplication | BOOLEAN | OPTIONAL -- |

Need R

| | |
|---|---|
| } | OPTIONAL, -- Cond |

MoreThanOneRLC

| t-Reordering | ENUMERATED { | |
|---|---|---|
| | ms0, ms1, ms2, ms4, ms5, ms8, ms10, ms15, ms20, ms30, ms40, | |
| | ms50, ms60, ms80, ms100, ms120, ms140, ms160, ms180, ms200, ms220, | |
| | ms240, ms260, ms280, ms300, ms500, ms750, ms1000, ms1250, | |
| | ms1500, ms1750, ms2000, ms2250, ms2500, ms2750, | |
| | ms3000, spare28, spare27, spare26, spare25, spare24, | |
| | spare23, spare22, spare21, spare20, | |
| | spare19, spare18, spare17, spare16, spare15, spare14, | |
| | spare13, spare12, spare11, spare10, spare09, | |
| | spare08, spare07, spare06, spare05, spare04, spare03, | |
| | spare02, spare01 } | OPTIONAL, -- Need S |

```
  ...,
  [[
```

| | | |
|---|---|---|
| cipheringDisabled | ENUMERATED {true} | OPTIONAL |

-- Cond ConnectedTo5GC
]]
}
UL-DataSplitThreshold ::= ENUMERATED {

b0, b100, b200, b400, b800, b1600, b3200, b6400, b12800, b25600,

b51200, b102400, b204800,

b409600, b819200, b1228800, b1638400, b2457600, b3276800,

b4096000, b4915200, b5734400,

b6553600, infinity, spare8, spare7, spare6, spare5, spare4, spare3,

spare2, spare1}

| | |
|---|---|
| DRB-Identity ::= | INTEGER (1..32) |

LogicalChannelIdentity ::= INTEGER (1..maxLC-ID)

| | |
|---|---|
| maxLC-ID | INTEGER ::= 32 |

If the UE is operating in standalone mode, it will usually have only one radio bearer configuration in the radioBearerConfig IE, that contains the higher layer configurations of that bearer. If the UE is operating in dual connectivity (DC) mode or is being prepared for DC (as it is possible to have a secondary node terminated bearer without any radio resource being allocated towards the secondary node, which is known as Secondary node terminated MCG bearer), then radioBearerConfig2 IE will contain the bearers that are associated with the secondary node.

The radioBearerConfig IEs contain the security setting of the bearers (e.g. encryption/integrity protection algorithms) and the configuration of the SDAP and PDCP layers.

The UE can be configured with one or more cell group configurations (cellGroupConfig) (in rel-15, this is limited to a maximum of two). In the cell group configuration, a lot of information is provided regarding the cells that are associated with the cell group. If the UE is operating in single connectivity, then it will have only one cell group configuration that contains configuration of the primary cell (PCell) and the secondary cells (SCells), if any, that are operating in carrier aggregation (CA) mode. And this cell group is known as the master cell group (MCG) configuration. If the UE is operating in DC, then it will have an additional cell group configuration called secondary cell group (SCG) configuration that contains the configuration of the primary secondary cell (PSCell) and secondary cells (SCells), if any, if the UE is operating in CA mode in the SCG as well.

Apart from the MCG/SCG Cells (PCell, PSCell, SCells) configurations, the cell group configurations also contain an RLC bearer configuration (RLC-BearerConfig) that is used to define the lower layer configurations for a given bearer (i.e. RLC/MAC). In the RLC bearer configuration, the servedRadioBearer IE associates the RLC bearer configuration with a particular bearer (be it a data radio bearer, DRB, or a signaling radio bearer, DRB).

A bearer can be associated with more than one RLC bearer configuration (if a bearer is a split bearer that uses the MCG and SCG, or it is a bearer belonging to the MCG or SCG only but uses duplication via carrier aggregation, known as CA duplication). In this case, the PDCP configuration (pdcpConfig) contains the moreThanOneRLC IE that links the PDCP with the two RLC bearers.

As can be seen in the signaling the Radio Bearer can be identified by a DRB ID, or SRB ID and a logical channel. The DRB/SRB IDs are used for different purposes such as input to PDCP encryption and/or integrity protection. The logical channel is used for MAC multiplexing.

### SUMMARY

Certain challenges presently exist. For example, as a consequence of the differences above between backhaul (BH) RLC channels and DRB it is not possible to reuse the existing DRB configuration in RRC signaling for setting up BH RLC channels. More details of this is provided below.

It has been agreed in 3GPP that one or more BH RLC channels should be supported between the IAB node and its parent node (which could be another IAB node or a Donor DU). These BH RLC channels are, at a high level, similar to RLC bearers that are used at the cell-group level and configured between an NR UE and a base station (gNB) or a gNB-DU to support Signalling Radio Bearers (SRBs) or Data Radio Bearers (DRBs) between UE and CU. They differ however in the following aspects:
1. The RLC bearers have a radio bearer (i.e. an entry in radioBearerConfig) associated with them which means that they also are associated with a PDCP layer entity, while the BH RLC channels do not have a PDCP layer, only RLC/MAC layers.
2. Both BH RLC channels and RLC bearers are associated with a MAC logical channel ID, but since it is expected that the number of BH RLC channels could be many more in order to support many connected UEs to the same IAB node, the logical channel IDs will be extended to support many more IDs than for RLC bearers (which is currently limited to 32 (maxLC-ID) in RRC signalling). It is for further study (FFS) if the logical channel extensions will be done in such a way that it can be used both for BH RLC channels and RLC bearers.
3. An RLC bearer is associated with a DRB or SRB, and in a CU-DU split architecture, the DRBs are associated with F1-U tunnels (GTP-U) which terminate in the parent node, while BH RLC channels only associated with the IAB MT context (IP address or Adaptation Layer address) in the parent node and no tunnel association at the F1 level is required.
   The forwarding to the next IAB node (for UL or DL traffic) in an intermediate IAB node is performed based on Adaptation Layer address received in the packet, and the mapping to the right BH RLC channel is based on information such as the incoming BH RLC channel.
   The forwarding to the IAB node in the Donor DU (for DL traffic) is performed based on the IP address of the IAB node, and the mapping to the right BH RLC channel is based on information such as the DiffServ Code Points or Flow Label of the incoming IP packet or the GTP TEID.
   The forwarding to the next IAB node in the access IAB node (i.e. IAB node serving UE traffic) (for UL traffic) may be performed based on the address of the Donor DU, and the mapping to the right BH RLC channel is based on information such as the GTP TEID of the UE bearer.
4. Currently the F1 signaling uses the DRB ID to identify the DRBs between the CU and DU, e.g. at setup/release of DRBs. The DRB ID field is however limited to 64 values.

As a consequence of the differences above between BH RLC channels and DRB it is not possible to reuse the existing DRB configuration in the RRC signaling for setting up BH RLC channels. Problems with using the existing DRB configuration in the RRC signaling for setting up BH RLC channels follow.

As discussed in the background section, each RLC bearer is associated with a DRB or SRB. As one of the objectives of the IAB work item was to reuse the rel-15 functionalities/specification as much as possible, it is preferable to reuse the RLC bearer/radioBearerConfig structures in RRC and IEs in the F1 messages to configure/reconfigure the BH RLC channels. However, due to the fundamental differences above (e.g. BH RLC channels not having associated DRBs, the limitation of the addressing space of LCIDs and DRB-IDs for the case of BH RLC channels, etc.), direct adoption of the existing messages/IEs is not possible.

The BH RLC channel does not have an SDAP/PDCP configuration so from this point of view it would not be needed to have it associated with a DRB/SRB, however it could still be desirable to reuse a similar RRC/F1 structure for BH RLC channel to have a way to identify them in case the CU wants to add or release them. E.g. the CU will send message indicating which BH RLC channel to add and will receive a message back indicating which BH RLC channel the DU has setup. The problem is that it is not possible to use the DRB ID field for this since the DRB ID is limited to 32 values in the message above. However, the servedRadioBearer structure is not directly extendable.

Embodiments described herein address these and other problems. For example, embodiments introduce several mechanisms that make it possible to reuse the DRB setup/modification RRC signaling to also manage BH RLC channels.

Several embodiments described further herein are summarized below:
1. The RLC bearer config IE may be used for configuring BH RLC channels, and a separate BH RLC channel ID may be introduced instead of relying on the DRB ID (DRB-Identity) field.
2. A separate BH RLC channel ID may be introduced, and a pre-defined value for DRB ID may be used, which can be used for some or all of the BH RLC channels in the RRC signaling.
   The pre-defined value could either be hard-coded in the standard, or be signaled in the servedRadioBearer struct. In any case, the pre-defined value of the DRB ID should be different from DRB IDs used for DRBs (the CU could ensure that the same DRB ID is not reused).
   In this embodiment, there is no need to change the conditions for including the servedRadioBearer struct since BH RLC channels will also be associated with DRB IDs.
3. An extension field for the DRB ID may be introduced, making it possible to signal larger values for the DRB ID in the RRC signaling. The existing DRB-Identity in servedRadioBearer may also be used.
   This embodiment could be used for both UEs and IAB nodes.
4. Instead of using a DRB ID or BH RLC channel ID to identify BH RLC channels in the RRC signaling, Logical Channel IDs may be used as the identifier for BH RLC channel management.

The detailed description section below gives a further elaboration of these embodiments and other related embodiments.

In embodiments 1 and 2 above the BH RLC channel ID could be used for BH RLC channel management e.g. when the CU sends a message to remove a BH RLC channel to the DU, it will identify this BH RLC channel with the BH RLC channel ID, which the DU could then use to generate RRC information which is sent the IAB node.

In embodiment 3 the extended DRB ID could be used for BH RLC channel management. E.g. when the CU sends a message to remove a BH RLC channel, it will identify this BH RLC channel with the extended DRB ID field, which the DU could then use to generate RRC information which is sent the IAB node.

In embodiment 4 it is possible to use BH RLC channel ID on the F1 interface between the DU and CU, but then the CU could translate this ID to the Logical Channel ID which is used in the RRC information towards the IAB node. Alternatively, it is possible to also signal the Logical Channel ID on the F1 interface between the CU and DU.

Embodiments make it possible to reuse many of the RRC messages and IEs that are currently used to setup, modify, and release DRBs to also be used for managing BH RLC channels. In this way the specification effort is minimized and duplicate specifications with similar but different content can be avoided. This also minimizes the implementation and testing effort for supporting IAB nodes, in networks already supporting UE DRBs.

According to a first aspect, a method for establishing a backhaul (BH) radio link control (RLC) channel between a node and a distributed unit (DU) is provided. The method includes the DU receiving an F1AP message from a central unit (CU). The method further includes the DU determining that the DU is capable to establish the BH RLC channel between the node and the DU in response to receiving the F1AP message. The method further includes the DU generating a radio resource control (RRC) configuration for the BH RLC channel. The RRC configuration includes: i) a BH-RLC-Identity value which indicates an identifier for the BH RLC channel, the BH-RLC-Identity field being part of a servedBHChannel Information Element (IE), or ii) a drb-Identity value that is associated with the BH RLC channel, or iii) a logical channel identity (LCID) value that is associated with the BH RLC channel, or iv) a RLC-ChannelConfig IE that includes an identifier for the BH RLC channel.

In some embodiments, the method further includes the DU establishing the DU-side of the BH RLC channel, including allocating memory for the RLC buffer. In some embodiments, the node comprises an integrated access and wireless access backhaul (IAB) node. In some embodiments, the DU comprises a donor DU providing wireless connectivity to the node. In some embodiments, the CU comprises a donor CU serving as the control and user plane termination point for the IAB node. In some embodiments, the F1AP message comprises a UE Context Setup Request or UE Context Modify Request message.

According to a second aspect, a method for establishing a backhaul (BH) radio link control (RLC) channel between a node and a DU is provided. The method includes a control unit (CU) receiving an radio resource control (RRC) configuration for the BH RLC channel from the DU. The RRC configuration includes: i) a BH-RLC-Identity value which indicates an identifier for the BH RLC channel, the BH-RLC-Identity field being part of a servedBHChannel Information Element (IE), or ii) a drb-Identity value that is associated with the BH RLC channel, or iii) a logical channel identity (LCID) value that is associated with the BH RLC channel, or iv) a RLC-ChannelConfig IE that includes an identifier for the BH RLC channel.

In some embodiments, the method further includes the CU generating an RRC Reconfiguration message based on the RRC configuration received from the DU; and the CU sending the RRC Reconfiguration message to the node. In some embodiments, the node comprises an integrated access and wireless access backhaul (IAB) node. In some embodiments, the DU comprises a donor DU providing wireless connectivity to the node. In some embodiments, the CU comprises a donor CU serving as the control and user plane termination point for the IAB node.

According to a third aspect, a method for establishing a backhaul (BH) radio link control (RLC) channel between a node and a distributed unit (DU) is provided. The method includes the node receiving a radio resource control (RRC) reconfiguration for the BH RLC channel from a control unit (CU). The RRC reconfiguration includes: i) a BH-RLC-Identity value which indicates an identifier for the BH RLC channel, the BH-RLC-Identity field being part of a servedBHChannel Information Element (IE), or ii) a drb-Identity value that is associated with the BH RLC channel, or iii) a logical channel identity (LCID) value that is associated with the BH RLC channel, or iv) a RLC-ChannelConfig IE that includes an identifier for the BH RLC channel. In some embodiments, the method further includes the node establishing the node-side of the BH RLC channel. In some embodiments, the node comprises an integrated access and wireless access backhaul (IAB) node. In some embodiments, the DU comprises a donor DU providing wireless connectivity to the node. In some embodiments, the CU comprises a donor CU serving as the control and user plane termination point for the IAB node.

According to a fourth aspect, a computer program is provided. The computer program includes instructions which when executed by processing circuitry of a network function apparatus causes the apparatus to perform the method of any one of the embodiments of the first, second, and third aspects.

According to a fifth aspect, a carrier is provided. The carrier contains the computer program of the fourth aspect, wherein the carrier is one of an electronic signal, an optical signal, a radio signal, and a computer readable storage medium.

According to a sixth aspect, a network function (NF) apparatus is provided. The NF apparatus is adapted to: receive an F1AP message from a control unit (CU); determine that a distributed unit (DU) is capable to establish a backhaul (BH) radio link control (RLC) channel between a node and the DU in response to receiving the F1AP message; and generate a radio resource control (RRC) configuration for the BH RLC channel. The RRC configuration includes: i) a BH-RLC-Identity value which indicates an identifier for the BH RLC channel, the BH-RLC-Identity field being part of a servedBHChannel Information Element (IE), or ii) a drb-Identity value that is associated with the BH RLC channel, or iii) a logical channel identity (LCID) value that is associated with the BH RLC channel, or iv) a RLC-ChannelConfig IE that includes an identifier for the BH RLC channel.

According to a seventh aspect, a network function (NF) apparatus is provided. The NF apparatus is adapted to: receive a radio resource control (RRC) configuration for a backhaul (BH) radio link control (RLC) channel from a distributed unit (DU). The RRC configuration includes: i) a BH-RLC-Identity value which indicates an identifier for the BH RLC channel, the BH-RLC-Identity field being part of a servedBHChannel Information Element (IE), or ii) a drb-Identity value that is associated with the BH RLC channel, or iii) a logical channel identity (LCID) value that is associated with the BH RLC channel, or iv) a RLC-ChannelConfig IE that includes an identifier for the BH RLC channel.

According to an eighth aspect, a network function (NF) apparatus is provided. The NF apparatus is adapted to: receive a radio resource control (RRC) reconfiguration for the backhaul (BH) radio link control (RLC) channel from a control unit (CU). The RRC reconfiguration includes: i) a BH-RLC-Identity value which indicates an identifier for the BH RLC channel, the BH-RLC-Identity field being part of a servedBHChannel Information Element (IE), or ii) a drb-Identity value that is associated with the BH RLC channel, or iii) a logical channel identity (LCID) value that is associated with the BH RLC channel, or iv) a RLC-ChannelConfig IE that includes an identifier for the BH RLC channel.

### BRIEF DESCRIPTION OF THE DRAWINGS

The accompanying drawings, which are incorporated herein and form part of the specification, illustrate various embodiments.

FIG. 1 shows a high level architectural view of an IAB network.

FIG. 2 shows user plane and control plane protocol stacks for IAB.

FIG. 3 shows user plane and control plane protocol stacks for IAB.

FIG. 4 is a flow chart illustrating a process according to some embodiments.

FIG. 5 is a flow chart illustrating a process according to some embodiments.

FIG. 6 is a block diagram illustrating an apparatus, according to an embodiment, for performing steps disclosed herein.

FIG. 7 is a block diagram illustrating an apparatus, according to an embodiment, for performing steps disclosed herein.

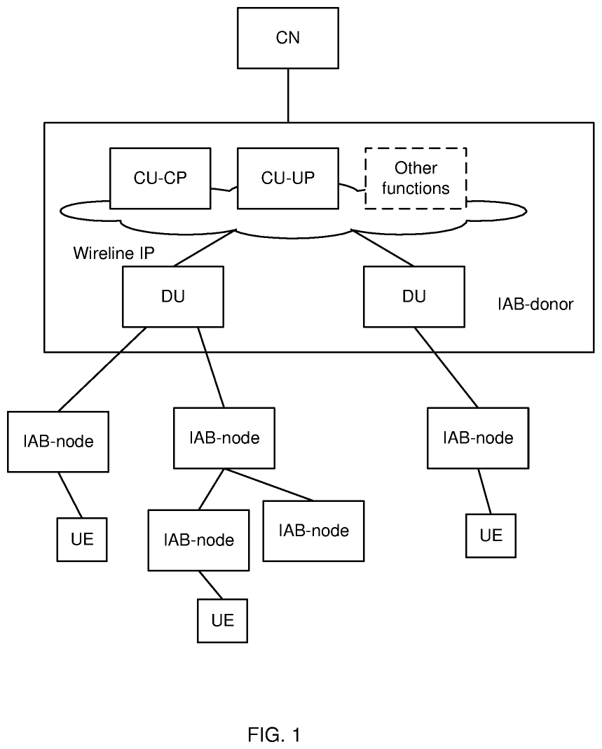

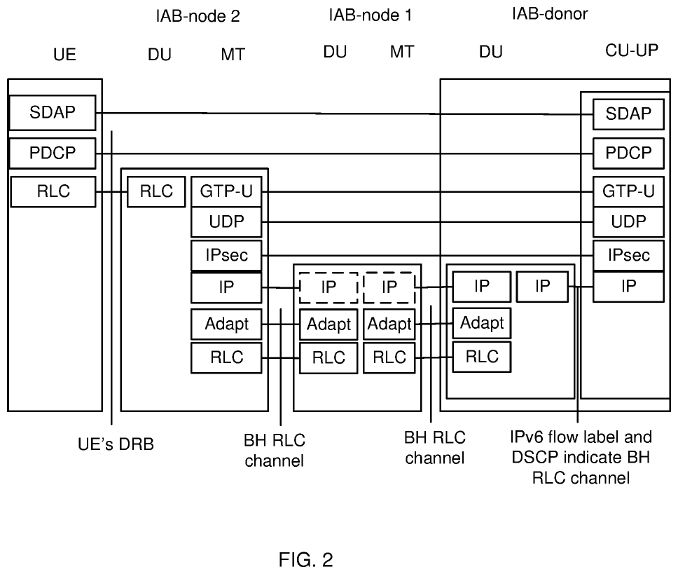

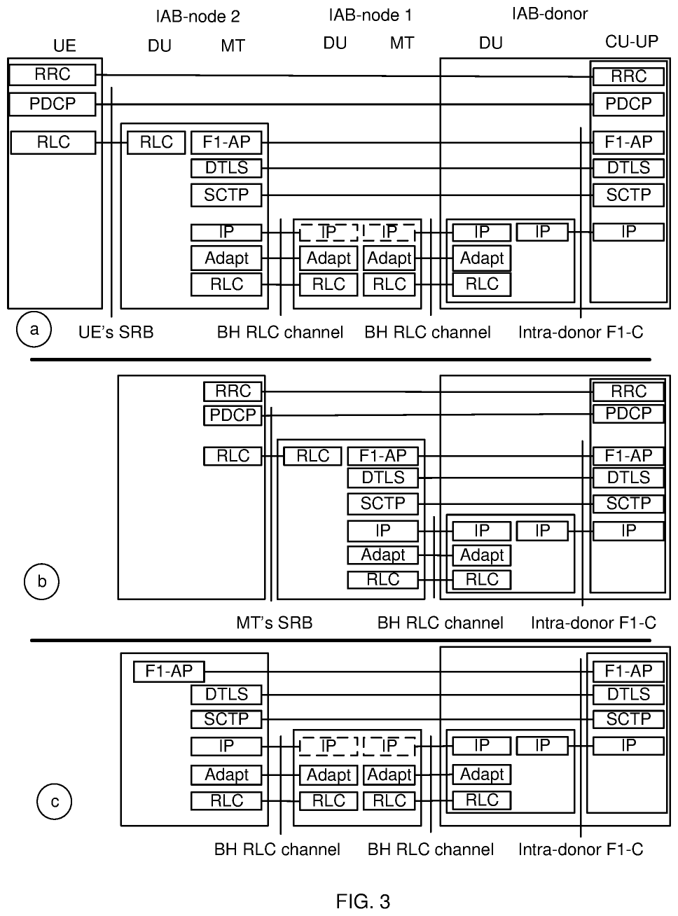

### DETAILED DESCRIPTION

Introduced herein are mechanisms for identifying the BH RLC channel in RRC signaling. The mechanisms make it possible for the donor IAB node or parent node (including DU and CU functionality) to signal to the IAB node to add, modify, or remove BH RLC channels. Where the BH RLC channel is added or modified, the RRC signaling from the donor or parent node may also include RLC/MAC level configuration information about the BH RLC channel. Embodiments address the reuse of the configuration information already defined for DRBs, thus avoiding extra elements to be defined for BH RLC channels.

Example Use Cases:
1. The Donor CU decides it needs to establish a new BH RLC channel between the IAB node 1 and the Donor DU. The triggering for this could, for instance, be based on that a new IAB node 2 connects to IAB node 1 or that a UE with a high priority or Guaranteed Bit Rate (GBR) service connects to IAB node 1.
2. The Donor CU sends a F1 application protocol (F1AP) message (e.g. a UE Context Setup (or Modify) Request message) to the donor DU to establish a new BH RLC channel towards IAB node 1. The BH RLC channel is identified with an identifier, which will be used for later signaling for this BH RLC channel.
3. The Donor DU will when it receives the request to setup a BH RLC channel determine if it is capable to fulfill the request. If it is, it will:
   a. generate an RRC configuration for this BH RLC channel. The RRC configuration could consist of a “CellGroupConfig” information element which in turn could consist of a “RLC-BearerConfig” element which includes an identifier of the BH RLC channel plus additional configuration information (e.g. RLC configuration)
   b. establish the DU side of the BH RLC channel, which could include allocating memory for the RLC buffer and other things.
4. The Donor DU sends this RRC configuration to the Donor CU which puts it into an RRC reconfiguration message to the IAB node.
5. When the IAB node receives the RRC reconfiguration message, it will establish the IAB node side of the BH RLC channel.

If the CU later decides to release the RLC BH channel, the following steps will be followed:
1. The Donor CU decides it needs to release a BH RLC channel between the IAB node 1 and the Donor DU. The triggering for this could, for instance, be based on that a UE in the IAB node 1 which had an ongoing service using the BH RLC channel is no longer using this service requiring this BH RLC channel.
2. The Donor CU sends a F1AP message (e.g. a UE Context Modify Request message) to the donor DU to release the BH RLC channel towards IAB node 1. The BH RLC channel is identified with an identifier which was assigned during the BH RLC channel setup.
3. The Donor DU will, when it receives the request to release a BH RLC channel, perform the following:
   a. generate an RRC configuration to release the BH RLC channel. The RRC configuration could include a “CellGroupConfig” information element which in turn could include a rlc-BearerToReleaseList which indicates which BH RLC channel should be released
   b. release the DU side of the BH RLC channel, which could include de-allocating memory for the RLC buffer and other things
4. The Donor DU sends this RRC configuration to the Donor CU which puts it into an RRC Reconfiguration message to the IAB node.
5. When the IAB node receives the RRC reconfiguration message it will release the IAB node side of the BH RLC channel indicated in the message.

The embodiments described below show different solutions for how the BH RLC channel can be identified, and different solutions for how this can be signaled in the RRC reconfiguration message. The embodiments also include solutions for translating between BH RLC channel identifiers in RRC and F1AP signaling.

### Embodiment 1

In one embodiment, the RLC Bearer configuration is enhanced to make it possible to configure backhaul RLC channels, as shown below.

| | |
|---|---|
| RLC-BearerConfig ::= | SEQUENCE { |
| logicalChannelIdentity | LogicalChannelIdentity, |
| servedRadioBearer | CHOICE { |
| srb-Identity | SRB-Identity, |
| drb-Identity | DRB-Identity |

} OPTIONAL, -- Cond LCH-SetupOnly

| | |
|---|---|
| reestablishRLC | ENUMERATED {true} OPTIONAL, -- Need N |
| rlc-Config | RLC-Config OPTIONAL, -- Cond LCH-Setup |
| mac-LogicalChannelConfig | LogicalChannelConfig OPTIONAL, -- Cond LCH- |

Setup
...

| | |
|---|---|
| servedBHChannel | BH-RLC-Identity OPTIONAL -Cond BH- |

RLC-SetupOnly

| | |
|---|---|
| logicalChannelIdentity-Ext | LogicalChannelIdentity-Ext OPTIONAL -Cond BH-RLC |

}
LogicalChannelIdentity-Ext := INTEGER (0..maxLCIDExt-1)

A description of the RLC-BearerConfig field descriptions in this embodiment follows in Table 1. An explanation of the conditional fields also follows in Table 2.

TABLE 1
RLC-BearerConfig field descriptions

logicalChannelIdentity
ID used commonly for the MAC logical channel and for the RLC bearer or BH RLC
channel.
reestablishRLC
Indicates that RLC should be re-established. Network sets this to TRUE whenever the
security key used for the radio bearer associated with this RLC entity changes. For SRB2
and DRBs, it is also set to TRUE during the resumption of the RRC connection or the
first reconfiguration after reestablishment.
rlc-Config
Determines the RLC mode (UM, AM) and provides corresponding parameters. RLC
mode reconfiguration can only be performed by DRB release/addition or full
configuration
servedRadioBearer
Associates the RLC Bearer with an SRB or a DRB. The UE shall deliver DL RLC SDUs
received via the RLC entity of this RLC bearer to the PDCP entity of the
servedRadioBearer. Furthermore, the UE shall advertise and deliver uplink PDCP PDUs
of the uplink PDCP entity of the servedRadioBearer to the uplink RLC entity of this
RLC bearer unless the uplink scheduling restrictions (‘moreThanOneRLC’ in PDCP-
Config and the restrictions in LogicalChannelConfig) forbid it to do so. This field is not
included in the case of BH RLC channel setup or modification
servedBHChannel
This ID is used to uniquely identify a backhaul RLC channel between two IAB nodes or
between an IAB donor DU and an IAB node. This field is required in BH RLC channel
setup and modification; it is absent otherwise. If this field is present, then the
servedRadioBearer field is not included
logicalChannelIdentity-Ext
This field, if included, will be used in conjunction with the logicalChannelIdnetity field
to determine the full logical channel ID for a backhaul RLC channel. The LCID of the
BH RLC channel will be the sum of the two fields (i.e. logicalChannelIdentity +
logicalChannelIdnetity-Ext)

TABLE 2

| Conditional | |
|---|---|
| Presence | Explanation |
| LCH-Setup | This field is mandatory present, Need M, |
| | upon creation of a new logical channel |
| | or BH RLC channel. It is optionally |
| | present otherwise. |
| LCH-SetupOnly | This field is mandatory present, Need M, |
| | upon creation of a new logical channel. |
| | It is absent otherwise. This field is absent |
| | when setting up BH RLC channels for an IAB node. |
| BH-RLC | This field is optionally present, Need M, |
| | upon the setup or modification of a |
| | BH RLC channel for an IAB node. |
| BH-RLCSetupOnly | This field is mandatory present, Need M, |
| | upon creation of a new backhaul |
| | RLC channel. It is absent otherwise. |

As can be seen above, a new IE called servedBHChannel has been introduced, and this is associated with a logical channel. If no logicalChannelIdentity-Ext is included, this logical channel will have an identity that is equal to the value indicated in the logicalChannelIdentity field. Otherwise, the logical channel will be assigned a value equal to the sum of logicalChannelIdentity and logicalChannelIdentity-Ext. This way, it will be possible to assign an LCID value that is large enough to accommodate the multitude of logical channels associated with BH RLC channels (the range of which is still not agreed in 3GPP). It should be also be noted that the conditions for the inclusion of servedRadioBearer has been changed to make it possible to configure the BH RLC channel without including this IE in the case of BH RLC channel configuration.

One feature of this embodiment is that a new BH-RLC-Identity field is introduced which may be used as a BH RLC channel identifier e.g. in the procedure described in the example use cases above.

### Embodiment 2

In one embodiment, the RLC Bearer configuration is enhanced to make it possible to configure backhaul RLC channels, as shown below.

| | |
|---|---|
| RLC-BearerConfig ::= | SEQUENCE{ |
| logicalChannelIdentity | LogicalChannelIdentity, |
| servedRadioBearer | CHOICE { |
| srb-Identity | SRB-Identity, |
| drb-Identity | DRB-Identity |

} OPTIONAL, -- Cond LCH-SetupOnly

| | |
|---|---|
| reestablishRLC | ENUMERATED {true} OPTIONAL, -- Need N |
| rlc-Config | RLC-Config OPTIONAL, -- Cond LCH-Setup |
| mac-LogicalChannelConfig | LogicalChannelConfig OPTIONAL, -- Cond LCH- |

Setup
...

| | |
|---|---|
| logicalChannelIdentity-Ext | LogicalChannelIdentity-Ext OPTIONAL -Cond BH-RLC |

}

| | |
|---|---|
| LogicalChannelIdentity-Ext := | INTEGER (0..maxLCIDExt-1) |

A description of the RLC-BearerConfig field descriptions in this embodiment follows in Table 3. An explanation of the conditional fields also follows in Table 4.

TABLE 3
RLC-BearerConfig field descriptions

logicalChannelIdentity
ID used commonly for the MAC logical channel and for the RLC bearer.
reestablishRLC
Indicates that RLC should be re-established. Network sets this to TRUE whenever the
security key used for the radio bearer associated with this RLC entity changes. For SRB2
and DRBs, it is also set to TRUE during the resumption of the RRC connection or the
first reconfiguration after reestablishment.
rlc-Config
Determines the RLC mode (UM, AM) and provides corresponding parameters. RLC
mode reconfiguration can only be performed by DRB release/addition or full
configuration
servedRadioBearer
Associates the RLC Bearer with an SRB or a DRB. The UE shall deliver DL RLC SDUs
received via the RLC entity of this RLC bearer to the PDCP entity of the
servedRadioBearer. Furthermore, the UE shall advertise and deliver uplink PDCP PDUs
of the uplink PDCP entity of the servedRadioBearer to the uplink RLC entity of this
RLC bearer unless the uplink scheduling restrictions (‘moreThanOneRLC’ in PDCP-
Config and the restrictions in LogicalChannelConfig) forbid it to do so.
logicalChannelIdentity-Ext
This field, if included, will be used in conjunction with the logicalChannelIdnetity field
to determine the full logical channel ID for a backhaul RLC channel. The LCID of the
BH RLC channel will be the sum of the two fields (i.e. logicalChannelIdentity +
logicalChannelIdnetity-Ext)

TABLE 4

| Conditional | |
|---|---|
| Presence | Explanation |
| LCH-Setup | This field is mandatory present, Need M, |
| | upon creation of a new logical channel |
| | or a BH RLC channel. It is |
| | optionally present otherwise. |
| LCH-SetupOnly | This field is mandatory present, Need M, |
| | upon creation of a new logical channel |
| | or a BH RLC channel. It is absent otherwise. |
| | In case of a BH RLC channel, the SRB-Identity |
| | cannot be configured and the same drb-Identity |
| | can be associated with several logical channels. |
| BH-RLC | This field is optionally present, Need M, |
| | upon the setup or modification of a BH RLC |
| | channel for an IAB node. |

As can be seen, the difference from Embodiment 1 is that no servedBHChannel IE is used and instead the servedRadioBearer field can be set with a drb-Identity value(s) that is(are) associated with BH RLC channels. For example, in one realization, the drb-Identity value of 4 is associated with all BH RLC channels, while the values 5 to 31 are used for data radio bearers and logical channels associated with them. In another example, the drb-Identity value of 4 is used for a subset of the BH RLC channels, while the rest of the BH RLC channels use the value of 5, and values 6 to 31 are used for data radio bearers and logical channels associated with them. The drb-identity value(s) to be associated with the BH RLC channels can be either fixed in the standards, or it can be configured by the network (i.e. via broadcast (e.g. system information) or dedicated signaling (e.g. RRC Connection Setup, Reconfiguration, etc.)).

In one realization of IAB deployment, an N:1 bearer mapping is employed and no LCID extension is required. In that case, the DRB space can also be reused, where for each BH RLC channel, a separate drb-Identity can be used, the same way as for normal DRBs.

### Embodiment 3

In one embodiment, the RLC Bearer configuration is enhanced to make it possible to configure backhaul RLC channels, as shown below.

| | |
|---|---|
| RLC-BearerConfig ::= | SEQUENCE { |
| logicalChannelIdentity | LogicalChannelIdentity, |
| servedRadioBearer | CHOICE { |
| srb-Identity | SRB-Identity, |
| drb-Identity | DRB-Identity |

} OPTIONAL, -- Cond LCH-SetupOnly

| | |
|---|---|
| reestablishRLC | ENUMERATED {true} OPTIONAL, -- Need N |
| rlc-Config | RLC-Config OPTIONAL, -- Cond LCH-Setup |
| mac-LogicalChannelConfig | LogicalChannelConfigOPTIONAL, -- Cond LCH- |

Setup
...

| | |
|---|---|
| drb-Identity-Ext | DRB-Identity-Ext OPTIONAL, -Cond BH-RLC |
| logicalChannelIdentity-Ext | LogicalChannelIdentity-Ext OPTIONAL -Cond BH-RLC |

}
DRB-Identity-Ext := INTEGER (0.maxDRB Ext-1)
LogicalChannelIdentity-Ext := INTEGER (0..maxLCIDExt-1)

A description of the RLC-BearerConfig field descriptions in this embodiment follows in Table 5. An explanation of the conditional fields also follows in Table 6.

TABLE 5
RLC-BearerConfig field descriptions

logicalChannelIdentity
ID used commonly for the MAC logical channel and for the RLC bearer.
reestablishRLC
Indicates that RLC should be re-established. Network sets this to TRUE whenever the
security key used for the radio bearer associated with this RLC entity changes. For SRB2
and DRBs, it is also set to TRUE during the resumption of the RRC connection or the
first reconfiguration after reestablishment.
rlc-Config
Determines the RLC mode (UM, AM) and provides corresponding parameters. RLC
mode reconfiguration can only be performed by DRB release/addition or full
configuration
servedRadioBearer
Associates the RLC Bearer with an SRB or a DRB. The UE shall deliver DL RLC SDUs
received via the RLC entity of this RLC bearer to the PDCP entity of the
servedRadioBearer. Furthermore, the UE shall advertise and deliver uplink PDCP PDUs
of the uplink PDCP entity of the servedRadioBearer to the uplink RLC entity of this
RLC bearer unless the uplink scheduling restrictions (‘moreThanOneRLC’ in PDCP-
Config and the restrictions in LogicalChannelConfig) forbid it to do so.
IDRBIdentity-Ext
This field, if included, will be used in conjunction with the drb-Identity field to
determine the DRB identity for a backhaul RLC channel. The DRB identity will be the
sum of the two fields (i.e. drb-Identity + drb-Identity-Ext)
logicalChannelIdentity-Ext
This field, if included, will be used in conjunction with the logicalChannelIdnetity field
to determine the full logical channel ID for a backhaul RLC channel. The LCID of the
BH RLC channel will be the sum of the two fields (i.e. logicalChannelIdentity +
logicalChannelIdnetity-Ext)

TABLE 6

| Conditional | |
|---|---|
| Presence | Explanation |
| LCH-Setup | This field is mandatory present, Need M, |
| | upon creation of a new logical channel |
| | or a BH RLC channel. It is |
| | optionally present otherwise. |
| LCH-SetupOnly | This field is mandatory present, Need M, |
| | upon creation of a new logical channel |
| | or a BH RLC channel. It is absent otherwise. |
| | In case of a BH RLC channel, the SRB-Identity |
| | cannot be configured and the same drb-Identity |
| | can be associated with several logical channels. |
| BH-RLC | This field is optionally present, Need M, |
| | upon the setup or modification of a |
| | BH RLC channel for an IAB node. |

As can be seen, no servedBHChannel IE is used and instead the servedRadioBearer field can be set with a drb-Identity value(s) that is(are) associated with BH RLC channels. A difference from Embodiment 2 is the inclusion of the lDRBIdentity-Ext field in Table 5 above, which allows, if included, the DRB identity to be determined based on both the drb-Identity and drb-Identity-Ext fields (e.g., as the sum of the two fields). For example, in one realization, the drb-Identity value of 4 is associated with all BH RLC channels, while the values 5 to 31 are used for data radio bearers and logical channels associated with them. In another example, the drb-Identity value of 4 is used for a subset of the BH RLC channels, while the rest of the BH RLC channels use the value of 5, and values 6 to 31 are used for data radio bearers and logical channels associated with them. The drb-identity value(s) to be associated with the BH RLC channels can be either fixed in the standards, or it can be configured by the network (i.e. via broadcast (e.g. system information) or dedicated signaling (e.g. RRC Connection Setup, Reconfiguration, etc.)).

In one realization of IAB deployment, an N:1 bearer mapping is employed and no LCID extension is required. In that case, the DRB space can also be reused, where for each BH RLC channel, a separate drb-Identity can be used, the same way as for normal DRBs.

### Embodiment 4

In one embodiment, the RLC Bearer configuration is enhanced to make it possible to configure backhaul RLC channels, as shown below.

| | |
|---|---|
| RLC-BearerConfig ::= | SEQUENCE { |
| logicalChannelIdentity | LogicalChannelIdentity, |
| servedRadioBearer | CHOICE { |
| srb-Identity | SRB-Identity, |
| drb-Identity | DRB-Identity |

}OPTIONAL, -- Cond LCH-SetupOnly

| | |
|---|---|
| reestablishRLC | ENUMERATED {true} OPTIONAL, -- Need N |
| rlc-Config | RLC-Config OPTIONAL, -- Cond LCH-Setup |
| mac-LogicalChannelConfig | LogicalChannelConfig OPTIONAL, -- Cond LCH- |

Setup
...

| | |
|---|---|
| logicalChannelIdentity-Ext | LogicalChannelIdentity-Ext OPTIONAL -Cond BH-RLC |

}
LogicalChannelIdentity-Ext :=INTEGER (0..maxLCIDExt-1)

A description of the RLC-BearerConfig field descriptions in this embodiment follows in Table 7. An explanation of the conditional fields also follows in Table 8.

TABLE 7
RLC-BearerConfig field descriptions

logicalChannelIdentity
ID used commonly for the MAC logical channel and for the RLC bearer.
reestablishRLC
Indicates that RLC should be re-established. Network sets this to TRUE whenever the
security key used for the radio bearer associated with this RLC entity changes. For SRB2
and DRBs, it is also set to TRUE during the resumption of the RRC connection or the
first reconfiguration after reestablishment.
rlc-Config
Determines the RLC mode (UM, AM) and provides corresponding parameters. RLC
mode reconfiguration can only be performed by DRB release/addition or full
configuration
servedRadioBearer
Associates the RLC Bearer with an SRB or a DRB. The UE shall deliver DL RLC SDUs
received via the RLC entity of this RLC bearer to the PDCP entity of the
servedRadioBearer. Furthermore, the UE shall advertise and deliver uplink PDCP PDUs
of the uplink PDCP entity of the servedRadioBearer to the uplink RLC entity of this
RLC bearer unless the uplink scheduling restrictions (‘moreThanOneRLC’ in PDCP-
Config and the restrictions in LogicalChannelConfig) forbid it to do so.
logicalChannelIdentity-Ext
This field, if included, will be used in conjunction with the logicalChannelIdnetity field
to determine the full logical channel ID for a backhaul RLC channel. The LCID of the
BH RLC channel will be the sum of the two fields (i.e. logicalChannelIdentity +
logicalChannelIdnetity-Ext)

TABLE 8

| Conditional | |
|---|---|
| Presence | Explanation |
| LCH-Setup | This field is mandatory present, Need M, |
| | upon creation of a new logical channel |
| | or a BH RLC channel. It is |
| | optionally present otherwise. |
| LCH-SetupOnly | This field is mandatory present, Need M, |
| | upon creation of |
| | a new logical channel or a BH RLC channel. |
| | It is absent otherwise. In case of a BH |
| | RLC channel, this field is absent |
| BH-RLC | This field is optionally present, Need M, |
| | upon the setup or modification of a BH |
| | RLC channel for an IAB node. |

This variant is similar to Embodiment 1 in that the servedRadioBearer field is not used for backhaul RLC channel setup. However, there is no servedBHChannel as in embodiment 1.

This variant is similar to Embodiment 2 from the ASN.1 point of view (i.e. only the LCID extension is introduced). However, unlike Embodiment 2, the drb-Identity is not used in this case.

Basically, the BH RLC channel is simply identified by the LCID (which could be the extended logical channel ID if logicalChannelIdentity-Ext) is included.

### Embodiment 5

In one embodiment, a new IE is defined to configure BH RLC channels

| | |
|---|---|
| RLC-ChannelConfig ::= | SEQUENCE { |
| logicalChannelIdentity | LogicalChannelIdentity |
| logicalChannelIdentity-Ext | LogicalChannelIdentity-Ext OPTIONAL |
| reestablishRLC | ENUMERATED {true} OPTIONAL, -- Need N |
| rlc-Config | RLC-Config OPTIONAL, -- Cond BH-RLC-Setup |
| mac-LogicalChannelConfig | LogicalChannelConfig OPTIONAL, -- Cond BH-RLC- |

Setup
...
}
LogicalChannelIdentity-Ext := INTEGER (0.. maxLCIDExt-1)

A description of the RLC-BearerConfig field descriptions in this embodiment follows in Table 9. An explanation of the conditional fields also follows in Table 10.

TABLE 9
RLC-ChannelConfig field descriptions

logicalChannelIdentity
ID used commonly for the MAC logical channel and for the RLC backhaul channel.
reestablishRLC
Indicates that RLC should be re-established. Network sets this to TRUE whenever the
security key used for the radio bearer associated with this RLC entity changes. For SRB2
and DRBs, it is also set to TRUE during the resumption of the RRC connection or the first
reconfiguration after reestablishment.
rlc-Config
Determines the RLC mode (UM, AM) and provides corresponding parameters. RLC mode
reconfiguration can only be performed by DRB release/addition or full configuration
logicalChannelIdentity-Ext
This field, if included, will be used in conjunction with the logicalChannelIdnetity field to
determine the full logical channel ID for a backhaul RLC channel. The LCID of the BH
RLC channel will be the sum of the two fields (i.e. logicalChannelIdentity +
logicalChannelIdnetity-Ext)

TABLE 10

| Conditional | |
|---|---|
| Presence | Explanation |
| BH-RLC-Setup | This field is mandatory present, Need M, |
| | upon creation of a new backhaul RLC channel. |
| | It is optionally present otherwise. |

The IE is similar to the RLC-BearerConfig IE used for configuring the RLC bearer of DRBs/SRBs, the main difference being that there is no information regarding served radio bearers.

The logical channel associated with the configuration supports the extended logical channel ID space, the range of which is still being discussed in 3GPP.

In one realization of IAB deployment, an N:1 bearer mapping is employed and no LCID extension is required. In that case, the there is no need to signal the logicalChannelIdentity-Ext.

### Combinations of Embodiments

It should be noted that the Embodiments 1-5 are possible to combine in various ways e.g. to use both logical channel extension and BH RLC channel identifiers in case it is desirable to manage the IEs separately or if the IEs are used in separate processes.

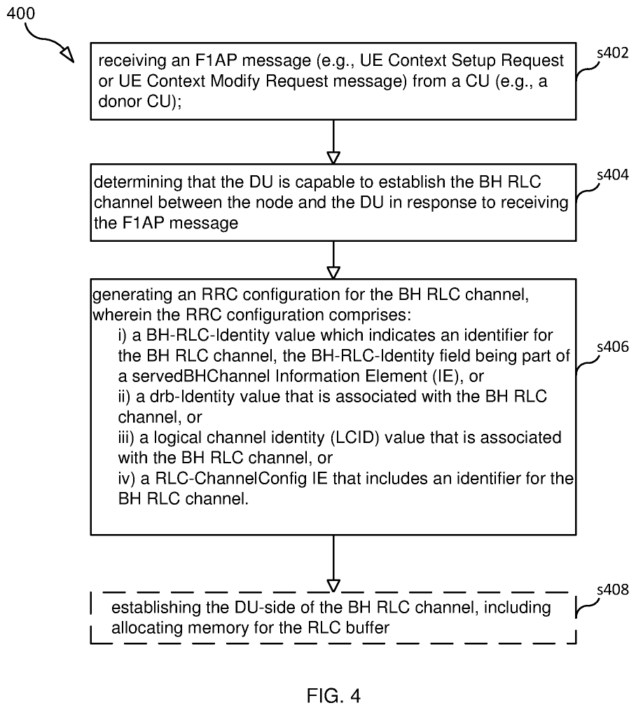

FIG. 4 is a flowchart illustrating a process 400 according to some embodiments. Process 400 may begin with step s402.

Step s402 comprises a DU (e.g., a donor DU) receiving an F1AP message (e.g., UE Context Setup Request or UE Context Modify Request message) from a CU (e.g., a donor CU).

Step s404 comprises the DU determining that the DU is capable to establish a BH RLC channel between a node (e.g., IAB node) and the DU in response to receiving the F1AP message.

Step s406 comprises the DU generating an RRC configuration for the BH RLC channel. The RRC configuration comprises: i) a BH-RLC-Identity value which indicates an identifier for the BH RLC channel, the BH-RLC-Identity field being part of a servedBHChannel Information Element (IE), or ii) a drb-Identity value that is associated with the BH RLC channel, or iii) a logical channel identity (LCID) value that is associated with the BH RLC channel, or iv) a RLC-ChannelConfig IE that includes an identifier for the BH RLC channel.

Step s408 (optional) comprises the DU establishing the DU-side of the BH RLC channel, including allocating memory for the RLC buffer.

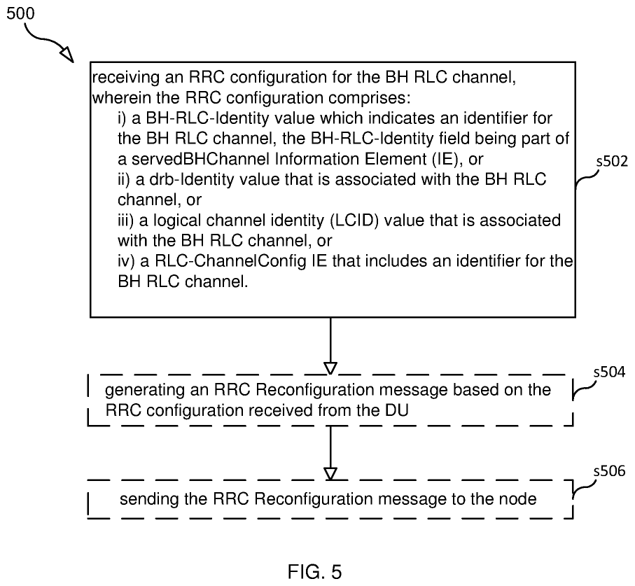

FIG. 5 is a flowchart illustrating a process 500 according to some embodiments. Process 500 may begin with step s502.

Step s502 comprises a CU (e.g. a donor CU) receiving an RRC configuration for a BH RLC channel from a DU (e.g. a donor DU). The RRC configuration comprises: i) a BH-RLC-Identity value which indicates an identifier for the BH RLC channel, the BH-RLC-Identity field being part of a servedBHChannel Information Element (IE), or ii) a drb-Identity value that is associated with the BH RLC channel, or iii) a logical channel identity (LCID) value that is associated with the BH RLC channel, or iv) a RLC-ChannelConfig IE that includes an identifier for the BH RLC channel.

Step s504 (optional) comprises the CU generating an RRC Reconfiguration message based on the RRC configuration received from the DU.

Step s506 (optional) comprises the CU sending the RRC Reconfiguration message to a node (e.g. IAB node).

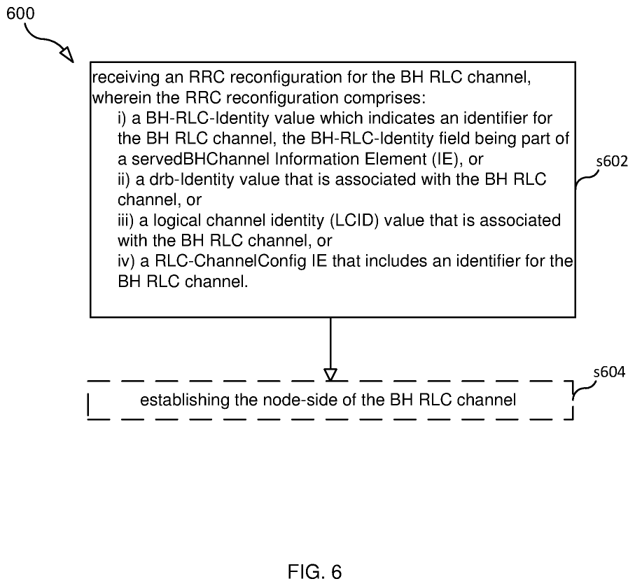

FIG. 6 is a flowchart illustrating a process 600 according to some embodiments. Process 600 may begin with step s602.

Step s602 comprises a node (e.g. IAB node) receiving an RRC reconfiguration for a BH RLC channel from a DU (e.g. donor DU). The RRC reconfiguration comprises: i) a BH-RLC-Identity value which indicates an identifier for the BH RLC channel, the BH-RLC-Identity field being part of a servedBHChannel Information Element (IE), or ii) a drb-Identity value that is associated with the BH RLC channel, or iii) a logical channel identity (LCID) value that is associated with the BH RLC channel, or iv) a RLC-ChannelConfig IE that includes an identifier for the BH RLC channel.

Step s604 (optional) comprises the node establishing the node-side of the BH RLC channel.

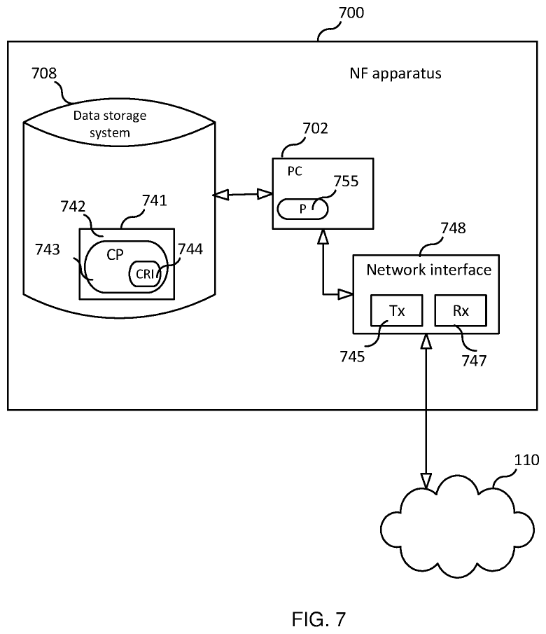

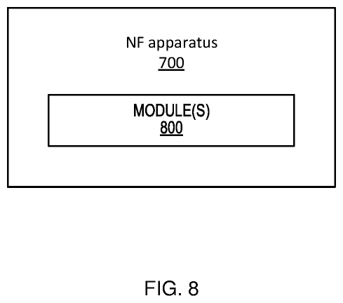

FIG. 7 is a block diagram of a network function (NF) apparatus 700, according to some embodiments. NF apparatus implements a CU or a DU. As shown in FIG. 7, NF apparatus 700 may comprise: processing circuitry (PC) 702, which may include one or more processors (P) 755 (e.g., a general purpose microprocessor and/or one or more other processors, such as an application specific integrated circuit (ASIC), field-programmable gate arrays (FPGAs), and the like), which processors 755 may be co-located in a single housing or in a single data center or may be geographically distributed (i.e., apparatus 700 may be a distributed apparatus); a network interface 748 comprising a transmitter (Tx) 745 and a receiver (Rx) 747 for enabling NF apparatus 700 to transmit data to and receive data from other nodes connected to network 110 (e.g., an Internet Protocol (IP) network) to which network interface 748 is connected; and a local storage unit (a.k.a., “data storage system”) 708, which may include one or more non-volatile storage devices and/or one or more volatile storage devices. In embodiments where PC 702 includes a programmable processor, a computer program product (CPP) 741 may be provided. CPP 741 includes a computer readable medium (CRM) 742 storing a computer program (CP) 743 comprising computer readable instructions (CRI) 744. CRM 742 may be a non-transitory computer readable medium, such as, magnetic media (e.g., a hard disk), optical media, memory devices (e.g., random access memory, flash memory), and the like. In some embodiments, the CRI 744 of computer program 743 is configured such that when executed by PC 702, the CRI causes NF apparatus 700 to perform steps described herein (e.g., steps described herein with reference to the flow charts). In other embodiments, NF apparatus 700 may be configured to perform steps described herein without the need for code. That is, for example, PC 702 may consist merely of one or more ASICs. Hence, the features of the embodiments described herein may be implemented in hardware and/or software.

FIG. 8 is a schematic block diagram of the NF apparatus 700 according to some other embodiments. The NF apparatus 700 includes one or more modules 800, each of which is implemented in software. The module(s) 800 provide the functionality of NF apparatus 700 described herein and, in particular, the functionality of the CU or DU described herein (e.g., the steps herein, e.g., with respect to FIG. 4 and/or FIG. 5 and/or FIG. 6).

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method for establishing a backhaul (BH) radio link control (RLC) channel between a node and a distributed unit (DU), the method comprising:
the DU receiving an F1AP message from a central unit (CU);
the DU determining that the DU is capable to establish the BH RLC channel between the node and the DU in response to receiving the F1AP message; and
the DU generating a radio resource control (RRC) configuration for the BH RLC channel, wherein the RRC configuration comprises:
a RLC-ChannelConfig IE that includes an identifier for the BH RLC channel.

2. The method of claim 1, further comprising the DU establishing the DU-side of the BH RLC channel, including allocating memory for the RLC buffer.

3. The method of claim 1, wherein the node comprises an integrated access and wireless access backhaul (IAB) node.

4. The method of claim 1, wherein the DU comprises a donor DU providing wireless connectivity to the node.

5. The method of claim 1, wherein the CU comprises a donor CU serving as the control and user plane termination point for the IAB node.

6. The method of claim 1, wherein the F1AP message comprises a UE Context Setup Request or UE Context Modify Request message.

7. A method for establishing a backhaul (BH) radio link control (RLC) channel between a node and a distributed unit (DU), the method comprising:
a control unit (CU) receiving a radio resource control (RRC) configuration for the BH RLC channel from the DU, wherein the RRC configuration comprises:
a RLC-ChannelConfig IE that includes an identifier for the BH RLC channel.

8. The method of claim 7, further comprising:
the CU generating an RRC Reconfiguration message based on the RRC configuration received from the DU; and
the CU sending the RRC Reconfiguration message to the node.

9. The method of claim 7, wherein the node comprises an integrated access and wireless access backhaul (IAB) node.

10. The method of claim 7, wherein the DU comprises a donor DU providing wireless connectivity to the node.

11. The method of claim 7, wherein the CU comprises a donor CU serving as the control and user plane termination point for the IAB node.

12. A method for establishing a backhaul (BH) radio link control (RLC) channel between a node and a distributed unit (DU), the method comprising:
the node receiving a radio resource control (RRC) reconfiguration for the BH RLC channel from a control unit (CU), wherein the RRC reconfiguration comprises: a RLC-ChannelConfig IE that includes an identifier for the BH RLC channel.

13. The method of claim 12, further comprising the node establishing the node-side of the BH RLC channel.

14. The method of claim 12, wherein the node comprises an integrated access and wireless access backhaul (IAB) node.

15. The method of claim 12, wherein the DU comprises a donor DU providing wireless connectivity to the node.

16. The method of claim 12, wherein the CU comprises a donor CU serving as the control and user plane termination point for the IAB node.

17. A non-transitory computer readable medium storing a computer program comprising instructions which when executed by processing circuitry of a network function apparatus causes the apparatus to perform the method of claim 1.

18. (canceled)

19. A network function (NF) apparatus, the NF apparatus being adapted to:
receive an F1AP message from a control unit (CU);
determine that a distributed unit (DU) is capable to establish a backhaul (BH) radio link control (RLC) channel between a node and the DU in response to receiving the F1AP message; and
generate a radio resource control (RRC) configuration for the BH RLC channel, wherein the RRC configuration comprises: a RLC-ChannelConfig IE that includes an identifier for the BH RLC channel.

20. The NF apparatus of claim 19, wherein the DU establishes the DU-side of the BH RLC channel, including allocating memory for the RLC buffer.

21. A network function (NF) apparatus, the NF apparatus being adapted to:
receive a radio resource control (RRC) configuration for a backhaul (BH) radio link control (RLC) channel from a distributed unit (DU), wherein the RRC configuration comprises: a RLC-ChannelConfig IE that includes an identifier for the BH RLC channel.

22. The NF apparatus of claim 21, further adapted to
generate an RRC Reconfiguration message based on the RRC configuration received from the DU; and
send the RRC Reconfiguration message to the node.

23. A network function (NF) apparatus, the NF apparatus being adapted to:
receive a radio resource control (RRC) reconfiguration for the backhaul (BH) radio link control (RLC) channel from a control unit (CU), wherein the RRC reconfiguration comprises: a RLC-ChannelConfig IE that includes an identifier for the BH RLC channel.

24. The NF apparatus of claim 23, further adapted to establish the node-side of the BH RLC channel.

25. The method of claim 1, further comprising the DU transmitting the RRC configuration to the CU.
